(19) United States
(12) Patent Application Publication
(10) Pub. No.: US 2008/0025475 A1
(43) Pub. Date: Jan. 31, 2008

(54) Apparatus for determining the position and orientation in medical imaging

(75) Inventor: David L. White, Oakland, CA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Synarc, Inc., San Francisco, CA (US)

(21) Appl. No.: 11/796,358

(22) Filed: Apr. 27, 2007

Related U.S. Application Data
(63) Continuation-in-part of application No. 11/492,437, filed on Jul. 25, 2006.
Application No. 11/492,437 is a continuation-in-part of application No. 11/492,627, filed on Jul. 25, 2006.

(51) Int. Cl. H05G 1/00

(52) U.S. Cl. 378/208

(57) ABSTRACT

The invention relates to a frame for positioning a hand for medical imaging. In one embodiment, the frame includes a plate having a first surface and a second surface, and at least one indicium of handedness on one of the first and second surface. In the embodiment, at least one indicium of the frame is positioned asymmetrically on one of the first and second surfaces. In another embodiment, while, at least one of the first and second surfaces is flat, the other surface is shaped to raise the fingers of the hand, and has a raised platform to support the wrist of said hand. The indicium is visible under medical imaging illumination. Medical imaging is selected from a group consisting of: X-Ray, MRI (magnetic resonance imaging), computed tomography (CT), and PET (position emission tomography).

### REFERENCE TO RELATED CASES

The present application is a continuation-in-part of U.S. patent application Ser. No. 11/492,627 entitled “An Apparatus for Positioning and Labeling an Appendage in X-Radiography” and U.S. patent application Ser. No. 11/492,437 entitled “An Apparatus for Determining the Position and Orientation of an X-Ray Source,” both filed Jul. 25, 2006, assigned to the assignee of the present invention, and incorporated herein by reference in their entirety.

### FIELD OF THE INVENTION

The invention relates generally to the field of medical imaging and specifically to the positioning of an appendage relative to a medical imaging device for capturing its image.

### BACKGROUND OF THE INVENTION

One of the challenges of radiography of the hands and feet is ensuring accurate labeling of the right and left sides. Currently, this is done by manually placing radio-opaque markers on the radiographic cassette at the time of film exposure. However, it is virtually impossible to verify retrospectively whether this was done correctly. In some cases, the presence of fortuitous anatomical asymmetries, such as remote unilateral fracture, provides definitive indicators of side, but these are rare and require additional discipline, effort and expertise on the part of the image interpreter.

Errors in right-left labeling can lead to misinterpretations of images. In clinical practice, this can result in serious mistakes in patient management, including surgical intervention. In a clinical trial setting, right-left mismatches between serial radiographs of the hands, wrists or feet of patients with rheumatoid arthritis can result in misinterpretation of progression of structural damage (bone erosion and joint-space narrowing) and therefore disease severity or treatment response. Inappropriately changing disease-modifying therapy in response to erroneous radiographic information can increase the cost and toxicity risk of treatment or result in under-treating progressively destructive rheumatoid arthritis, exposing patients to preventable joint damage and irreversible disability. Misinterpreting therapeutic efficacy in clinical trials of new therapies for rheumatoid arthritis can result in poor decision making by pharmaceutical companies and regulatory agencies leading to approval of ineffective therapies or rejection of effective ones. Accordingly, a fail-safe method for accurately labeling the right and left side in radiography of the hands, wrists and feet is an important unmet need in radiography today.

### SUMMARY OF THE INVENTION

Embodiments of the present invention provide a device for determining the position and orientation in medical imaging. In more specific terms, embodiments of the present invention provide a positioning device with one or more intrinsic fiducial markers that keep a body part in a favorable position for medical imaging, and such markers allow unequivocal identification of the imaged body part as right or left.

The invention relates to a frame for positioning a hand for medical imaging. In one embodiment, the frame includes a plate having a first surface and a second surface, and at least one indicium of handedness on one of the first and second surfaces. In the embodiment, at least one indicium of the frame is positioned asymmetrically on one of the first and second surfaces. In another embodiment, while at least one of the first and second surfaces is flat, the other surface is shaped to raise the fingers of the hand, and has a raised platform to support the wrist of said hand. The indicium is visible under medical imaging illumination. Medical imaging is selected from a group consisting of: X-Ray, MRI (magnetic resonance imaging), computed tomography (CT), and PET (position emission tomography). The plate can be x-ray transparent or translucent.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a perspective view of an embodiment of a frame constructed in accordance with the invention, positioned above an x-ray cassette;

FIG. 2 is a side view of the frame of FIG. 1 with a hand positioned upon it;

FIG. 3 is a plan view of another embodiment of the frame constructed in accordance with the invention;

FIG. 4 is a plan view of yet another embodiment of the frame constructed in accordance with the invention;

FIG. 5A is perspective view of an embodiment of a frame constructed in accordance with another embodiment of the invention;

FIG. 5B is a plan view of the plate of FIG. 4 from an orthogonal view point directly above the plate;

FIG. 5C is a plan view of the plate of FIG. 4 from a non-orthogonal view point above the plate; and

FIG. 5D illustrates two overlapping orthogonal plan views of the plate of FIG. 4 at two different magnifications.

FIG. 6 is a perspective view of an embodiment of a frame constructed in accordance with the invention.

FIGS. 7A and B are x-ray images taken of an individual's LEFT (A) and RIGHT (B) hands respectively, using conventional radio-opaque “L” and “R” markers labeling left and right above the thumb portion of the hand during exposure of the x-ray film.

FIG. 7C is an image produced by horizontally flipping FIG. 6.

FIG. 8A is a plan view of the frame of FIG. 6 with a LEFT hand positioned upon it.

FIG. 8B is a plan view of the frame of FIG. 6 with a RIGHT hand positioned upon it.

FIG. 9A is an MR image of a RIGHT hand in an embodiment of the frame in the axial plane.

FIG. 9B is an MR image of the RIGHT hand in an embodiment of the frame in the sagittal plane.

FIG. 9C is an MR image of the RIGHT hand in an embodiment of the frame in the coronal plane.

FIG. 10A is a plan view of a RIGHT hand positioned on the top surface of the frame.

FIG. 10B is a plan view of a LEFT hand positioned on the bottom surface of the frame.

FIG. 11A is an MR image of a LEFT hand positioned on the bottom surface of the frame in the axial plane.

FIG. 11B is an MR image of a LEFT hand positioned on the bottom surface of the frame in the sagittal plane.

FIG. 11C is an MR image of a LEFT hand positioned on the bottom surface of the frame in the coronal plane.

### DETAILED DESCRIPTION

This application incorporates by reference the co-pending U.S. Patent Applications “An Apparatus for Positioning and Labeling an Appendage in X-Radiography” (Attorney docket number SYN-002A) and “An Apparatus for Determining the Position and Orientation of an X-Ray Source” (Attorney docket number SYN-002B), assigned to the assignee of the present invention and filed on Jul. 25, 2006.

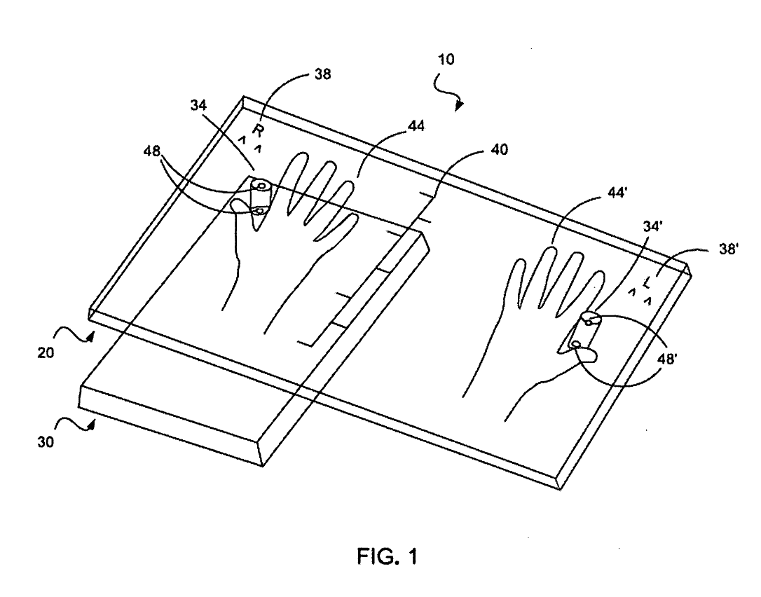

Referring to FIG. 1, an embodiment of a frame 10 constructed in accordance with the invention includes a flat radio-translucent or transparent plate 20 that is sized and shaped for placement on top of a radiographic cassette 30. The radiographic cassette 30 may contain x-ray film or may itself be a digital detector for use. On the top surface of the plate 20 are one or more protrusions (in this embodiment, pegs) 34, 34′ that prevent the frame 10 from being positioned upside down and also serve as guides for palmar and plantar placement of the hand or foot, respectively. In the embodiment shown, one plate 20 is configured with both right and left appendages on the same plate 20. The plate 20 in this embodiment is approximately twice the width of the cassette 30 and hence either the left or the right half of the plate 20 is positioned on the cassette 30 of a given time. Other embodiments may be configured for use solely with the right or left hand or foot. Accordingly, the plates in these embodiments have the same width as the cassette. The protrusions or pegs 34, 34′ prevent positioner from lying flat on the cassette 30 when one attempts to place the frame 10 upside-down. This has the consequence of preventing inversion errors, which have the effect of displaying a planar representation of an object as its mirror image. (This is what happens when a radiograph is “flipped”; absent an “R”/“L” marker, there is no way of unequivocally determining whether the radiograph of a hand is of a left or a right hand.)

In one embodiment, “R” and “L” radio-opaque markers 38, 38′ are permanently affixed to the plate 20. The fact that both the radio-opaque markers 38, 38′ and the hand (or foot) are each asymmetric and chiral (that is, an object's mirror image is not superimposable upon the object itself) means that handedness (Right/Left) of a hand (or foot) can be determined unequivocally when its x-ray image is obtained in conjunction with the radio-opaque markers 38, 38′.

In another embodiment, radio-opaque fiducial markers, rulers 40, and/or appropriately oriented radio-translucent indicia of the hand 44, 44′ and foot alignment marks are also affixed to one of the surfaces of the plate 20. In still yet another embodiment, radio-opaque beads 48, 48′ may be positioned on the proximal and/or distal poles of one or more radio-translucent pegs 34, 34′. By comparing the projected positions of these beads 48, 48′ relative to one another and/or those of the “R”/“L” markers 38, 38′ or other fiduciary markers 34, 34′ on serially acquired radiographs, one can determine whether the beam centering and angulation used on the serial images are the same. This assists the reader in differentiating true anatomical changes from those due to projectional variations and is described in more detail below.

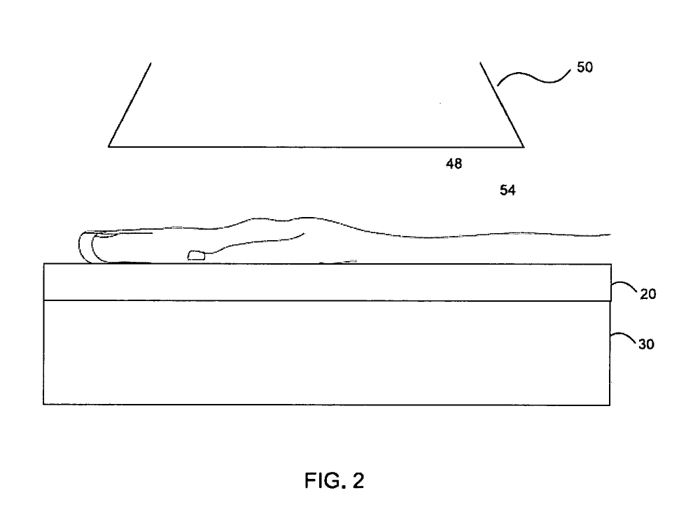

In use and referring to FIG. 2, wrist-hand radiographs are typically obtained with the patient seated with his forearm and hand horizontal to his side. The frame 10 is placed on the x-ray film cassette 30, with the surface opposite the protuberance 48 placed against the cassette 30. The cassette 30 and frame 10 are placed on the table of the x-ray machine, with the x-ray source 50 above. The patient's hand 54 is placed on the frame 10 adjacent the protuberance 48 with the palm against the surface of the plate 20. This exposure is dorsal-palmar.

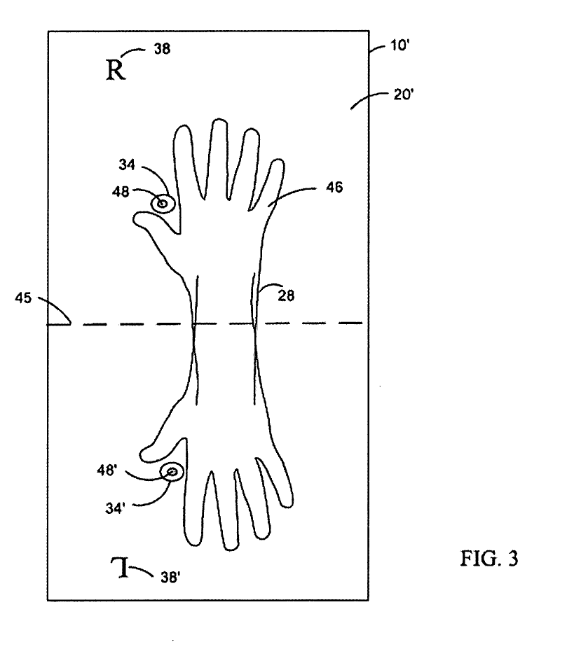

Another embodiment of the frame 10 is shown in FIG. 3. In this embodiment, the frame 10 has approximately the same width as the cassette (or a hand), but nevertheless may be used for both the left and right appendages. Instead of having separate radio-translucent alignment marks 44, 44′ for the right and left hands on a frame 10 approximately twice the width of the cassette 30 as shown in FIG. 1, the plate 20′ illustrated in FIG. 3 contains a single radio-translucent mark 46 shaped as a left and a right hand overlapping each other with their palms and pointing in opposite directions such that the thumbs on both hands are on the same side of the plate 20′. As a result, the outline of the mark 46 is symmetrical as to an imaginary line 45 across the middle of the plate 20′.

Still referring to FIG. 3, similar radio-opaque markers, such as pegs 34, 34′, “R”/“L” markers 38, 38′, and beads 48, 48′ positioned on proximal and/or distal poles of the pegs 34, 34′, may also be placed on the plate 20′ to verify the handedness of appendages and to prevent the plate 20′ from being placed upside-down on a cassette when in use. In this embodiment, a radio-opaque “R” marker 38 is placed on the thumb side of the right hand outline, and an inverted radio-opaque “L” marker 38′ is placed on the thumb side of the left hand outline. As shown in FIG. 3, the “R”/“L” markers 38, 38′ are respectively on the top and bottom left corners of the plate 20′. Similarly, two radio-opaque pegs 34, 34′ are each positioned between the thumbs and the index fingers of the outline 46 of the right and left hand respectively. For a right hand radiograph, the frame 10′ is positioned over the top of a cassette so that the right hand can be comfortably placed palm down on top of the frame 10′ in alignment with the right hand half of the outline 46 on the plate 20′ with the upright “R” marker 38 next to the thumb. The plate 20′ may be rotated 180 degrees about its center so that a left hand radiograph may be taken by positioning the left hand palm down on top of the frame 10′ in alignment with the left hand half of the outline 46 with the upright “L” 38′ next to the thumb.

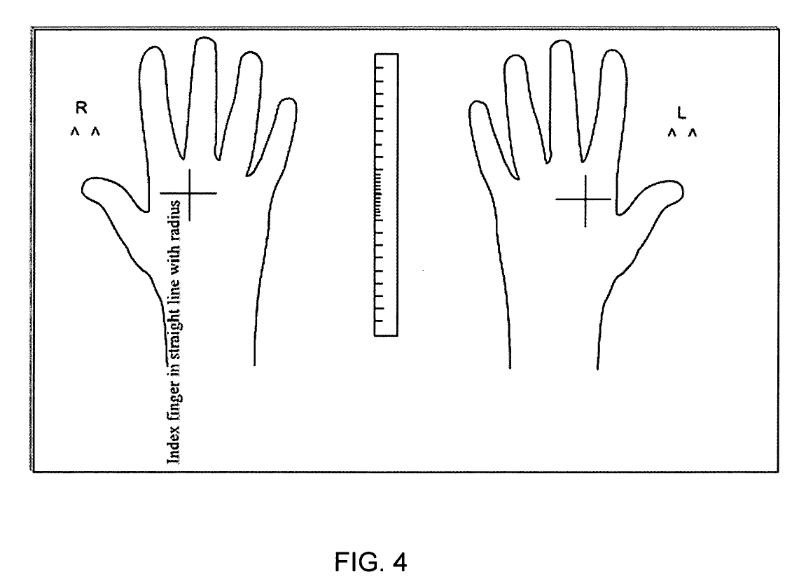

Yet another embodiment of the frame 10 is shown in FIG. 4. Similar to the previous embodiment, the frame 10 also has approximately the same width as the cassette (or a hand) and can be used for both the left and right hands. However, in this embodiment, the two overlapping radio-translucent marks 44, 44′, shaped as a left hand and a right hand respectively, point in the same direction. As such, the thumb of the right hand appears on the left side of the plate 20 and the thumb of the left hand appears on the right side of the plate 20. A radio-opaque “R” marker 38 is placed on the right thumb side and a radio-opaque “L” marker 38′ is placed on the left thumb side also to indicate the handedness of the appendages positioned on the plate. Similarly, radio-opaque pegs 34, 34′ may be positioned between the thumbs and the index fingers of the outlines of the right and left hand respectively. Unlike the frames 20 discussed in the previous embodiments, the frame 20 illustrated in FIG. 4 does not have to be rotated or translated when used for taking radiographs of both hands.

Regardless of which embodiment of the frame is used, the combination of pegs 34, 34′, permanently affixed radio-opaque “R” 38 and “L” 38′ labels and, optionally, radio-translucent outlines of hands 44, 44′, 46 and feet make incorrect placement of the hand (foot) immediately obvious to the user. Even if the user persists in incorrectly locating the hand (foot) on the positioner, the mistake(s) will be readily discernable on the resulting radiographs, and the true right/left identity of the hand (foot) can be ascertained from the radiographic image alone. This invention makes mistaken positioning of appendage readily discernable.

These points are illustrated in the following examples.

When correctly positioned, the fingers of the radio-translucent tracing point forward and the appropriate “R” or “L” label appears above the thumb. For the right wrist/hand, for example, the left end of the positioner is next to the patient. This locates the “R” radio-opaque marker above the right thumb.

The effect of horizontal translation of the frame is a noticeably more awkward position for the patient, which in itself will discourage this error. Additionally, the hand will not match the radio-translucent hand outline. However, a radiograph obtained in this manner will be immediately identifiable, as the “R” or “L” marker will appear right-side-up above the little finger. Note that the marker will be incorrect; the right hand will have an “L”, and vice-versa.

If a rotation of the frame is made about its center, the hand will not match the radio-translucent hand outline, and a radiograph obtained in this manner also will be immediately identifiable. In this case, the “R” or “L” marker will appear upside down (pointed away from the direction of the fingers) beneath the thumb. Note that the marker will be incorrect; the right hand will have an “L”, and vice-versa.

The effect of rotation and translation of the frame is that the hand will not match the radio-translucent hand outline, and a radiograph obtained in this manner also will be immediately identifiable. In this case, the “R” or “L” marker will appear upside down (pointed away from the direction of the fingers) beneath the little finger. Note that the marker will be correct; the right hand will have an “R”, and vice-versa.

Foot radiographs are usually obtained with the patient lying supine on the table of the x-ray machine. The knee is flexed so that the foot is placed flat upon the frame which is in turn placed on the x-ray film cassette with the x-ray source above. The exposure is dorsal-plantar. Analogously to the hand, correct use of the frame places the appropriate “R” or “L” marker immediately adjacent to the great toe.

The appearance of the hand (foot) and radio-opaque label in radiographs obtained with the combinations of hand (foot) location with respect to the frame are summarized in Tables 1 and 2. Thus, the positioning and labeling frame disclosed herein solves the problem of unequivocally labeling right and left in hand and foot radiographs.

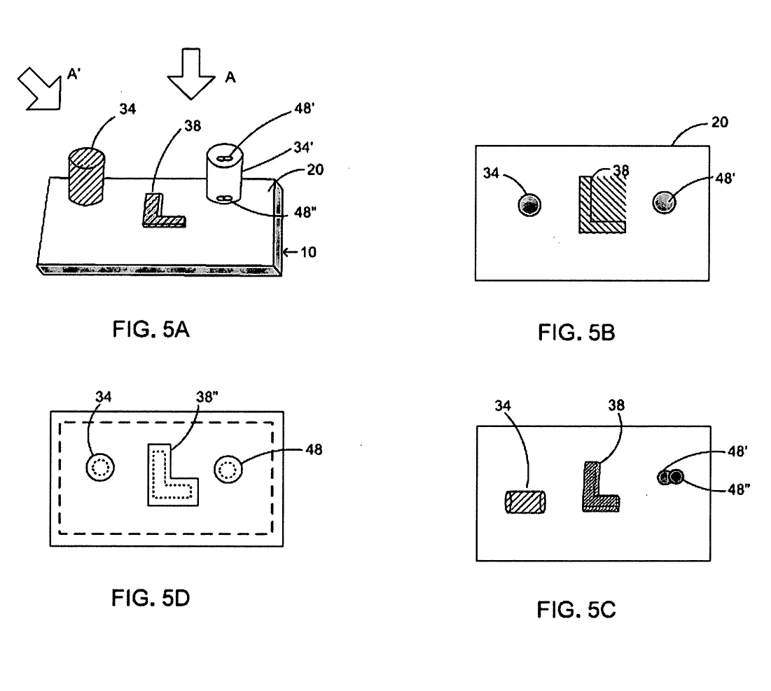

Not only do the embodiments of the invention accurately label the right and left side in radiography of the hands, wrists and feet, the embodiments can also indicate whether the beam centering, magnification and angulation used on the serial images are the same. FIGS. 5A, B, C and D illustrate that by comparing the projected positions of the radio-opaque markers, one can differentiate true anatomical changes from those due to projectional variations.

FIG. 5A is a perspective view of a frame 10 with a plurality of different radio-opaque markers capable of determining the magnification, centering and angulation of the x-ray source relative to the plate. Each of the three markers used in this embodiment of the frame are used for indicating the handedness of an appendage and may be used individually or in combination with one another. A radio-opaque perpendicular peg 34, a radio-opaque “L” marker 38, and a radio-translucent perpendicular peg 34′ with radio-opaque bead 48′, 48″ on its proximal and distal end, are affixed to the first surface of the plate 20.

FIG. 5B is a plan view of the plate 20 in FIG. 5A. The x-ray source is positioned is orthogonally above the plate 20 (arrow A in FIG. 4) so that the line of sight is perpendicular to the surface and the three markers 34, 48′, 38 thereon. As a result, the top and bottom surfaces of the markers 34, 48′, 38 are aligned and the x-ray beam is blocked by the markers. In the radiography context, this view represents a radiograph taken when the radiation source is positioned perfectly perpendicular to the surface.

However, if the radiation source is angularly displaced, tilted slightly, (arrow A′ in FIG. 5A) the radiation impinges on the markers at an angle different from perpendicular. As a result a different view of the same markers 34, 48′, 38 is obtained. As shown in FIG. 5C, because all three markers are radio-opaque, there are elongated images, like shadows of each of them projected on the plate 20. The differences in the two images (FIGS. 5B and C) are not the result of any changes to the markers 34, 48′, 38 themselves, but of changes in the angulation of the radiography—the angle between the radiation source and the plate. When a radiation source is not positioned perfectly perpendicular to the plate, a different image will be captured even though the object under radiation remains the same. As illustrated, the use of the radio-opaque markers on plate constructed in accordance with an embodiment of the invention makes it possible to visually identify such changes in angulation, as demonstrated by the comparison of FIGS. 5B and C. So for example radio-opaque peg 34 appears elongated when the x-ray image is not perpendicular. Similarly, the images of the two beads 48′ and 48″ located at the ends of peg 34 are no longer superimposed when the source is at an angle to the plate but instead appear as two spots. Finally, the image of the letter “L” 38 appears distorted because of the angulation. Thus the fact that the x-ray source is not perpendicular to the plate is easily detected.

Referring to FIG. 5D, serial images of the same appendage taken using an embodiment of the present invention may also be compared to see whether the differences in the images are due to changes in magnifications instead of true anatomical changes to the appendage. FIG. 5D illustrates two overlapping plan views of the same plate 20 on which the same markers 34, 48, 38 are attached. As outlined by dotted and solid lines respectively, the two images do not perfectly overlap each other. The solid line view looks to be a magnified image of the dotted line view as a result of the different distances at which the source was positioned from the plate 20. The markers 34, 48, 38 outlined by dotted lines represent a view from a more distant view point in the same line of sight, and the solid lines represent a closer view of the plate 20. By comparing the relative sizes of the images, one reading the x-ray can determine that the relative sizes are different and hence the magnification is different, when the same sized markers are used for each image.

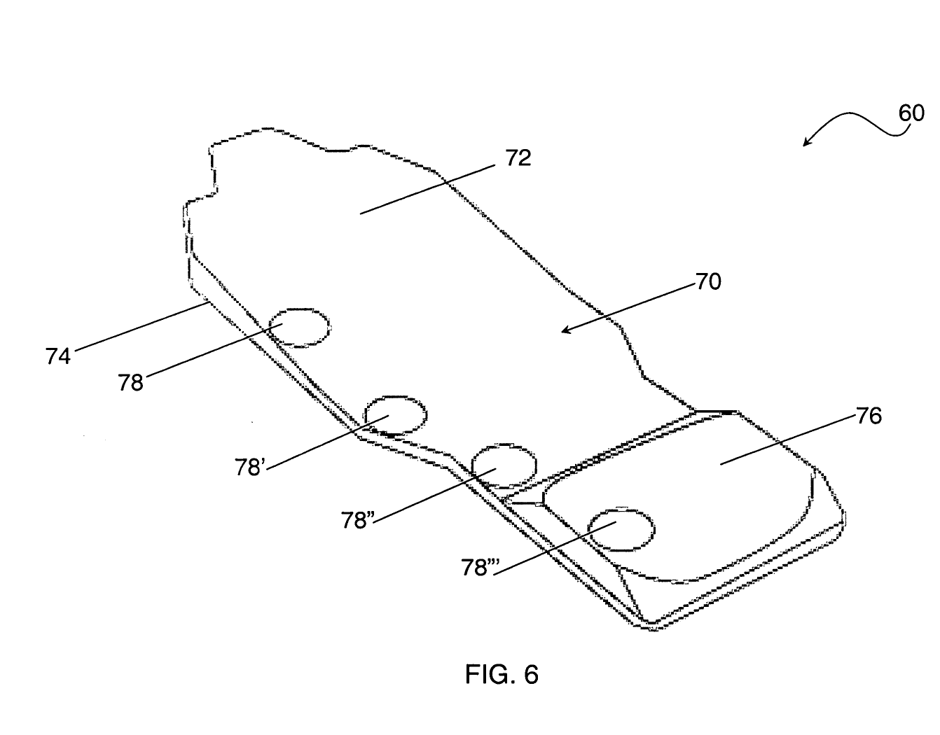

In another embodiment as illustrated in FIG. 6, a frame 60 constructed in accordance with the invention includes a plate 70 that is sized and shaped for medical imaging. Medical imaging modalities suitable to be used with this invention may include, but are not limited to, x-ray, MRI (magnetic resonance imaging), computed tomography (CT), and PET (positron emission tomography). When used for x-ray and CT imaging, the plate 70′ is transparent or radio-translucent. When used for MRI, or PET, the plate 70″ is made from an MRI- or PET-compatible material. The plate 70 has a top surface 72 and a bottom surface 74, and has a wedge-shaped side profile tapering at one end. A support 76 is positioned at the tapered end of the plate 70 on the top surface 72. In one embodiment, the wedge-shape plate 70 is adapted to raise the fingers, and the support 76 serves as a platform to support the wrist. In another embodiment, the side profile of the plate 70 may have a uniform width.

One or more fiducial markers 78, 78′, 78″ and 78′″ (collectively referred to as 78 thereafter) are positioned asymmetrically on the top surface 72 of the plate 70 as visible indicia of right/left assignment for capturing medical images. The asymmetry of the marker placement is relative to the sagittal anatomical plane (i.e., right/left). The appearance of the marker(s) along with the anatomical structure in the tomographic image, or set of images, allows the unequivocal retrospective assignment of right or left handedness to the imaged anatomy.

Referring to FIG. 6, two fiducial markers 78 are positioned asymmetrically on the left side of the top surface 72 in this embodiment of the invention. The markers can be placed on the top surface 72 of the plate 70, or embedded in the plate 70 extending within or through the plane of the hand and wrist in the anatomical coronal plane. No markers are placed on the right side of the top surface 70. The image of a hand can be identified unequivocally as right or left based on the relative positions of the asymmetric placement of the markers 78 to the thumb and palmar sides.

The composition of the fiducial markers 78 renders them visible in the resulting images. For example, electron dense materials would be suitable for x-ray imaging, while proton-containing substances would be required for proton MRI. In some cases, a single substance may serve for more than one imaging modality. Multi-modality markers (MM3002 Multi-Modality IGS/CAS Fiducial Marker and MM3003 Multi-Modality NucMed/PET Marker, IZI Medical Products, Baltimore, Md.) can be displayed on all imaging modalities, and can be used in the present invention. They appear as bright objects on CT, MRI, PET and nuclear medicine scans and can be seen on MRI sequences. MM3002 Multi-Modality IGS/CAS markers are round in shape, and are made of a hydrogel component. For nuclear medicine and PET imaging, short-life radionuclide can be injected in the liquid-containing wells at the center of the multi-modality markers for detection in the imaging process.

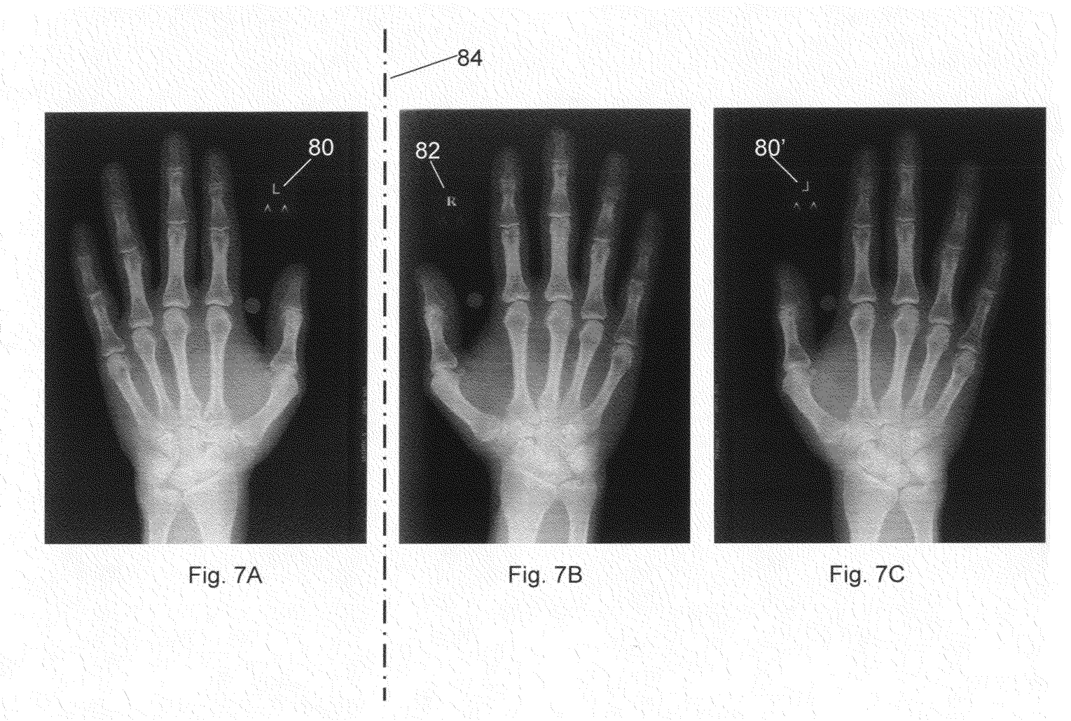

To see how difficult it is to determine the right/left assignment on medical images of hands and wrists that are labeled using conventional fiducial “L” and “R” markers, FIGS. 7A and B are x-ray images taken of an individual's left and right hands respectively, using conventional radio-opaque “L” and “R” markers 80 and 82 labeling left and right above the thumb portion of the hand during exposure of the x-ray film. An individual's left and right hands and wrists are effectively related by an apparent mirror plane of symmetry 84. Thus, flipping the image of a left hand across this mirror plane 84, as illustrated in FIG. 7C, that is almost identical to that of the corresponding right hand as in FIG. 7B except for the flipped “L” marker 80′. This is also true for both projection of images such as conventional x-ray radiographs or tomographic representations such as CT or MR images. Although there may be macroscopic or microscopic structural differences between an individual's left and right hands and wrists, it is usually impossible to determine which is which from the images of the anatomical structures alone. For images with mislabeled or missing markers or images that have been flipped or inversed, it is difficult to determine the right/left assignment of an image that is mislabeled, flipped or inversed.

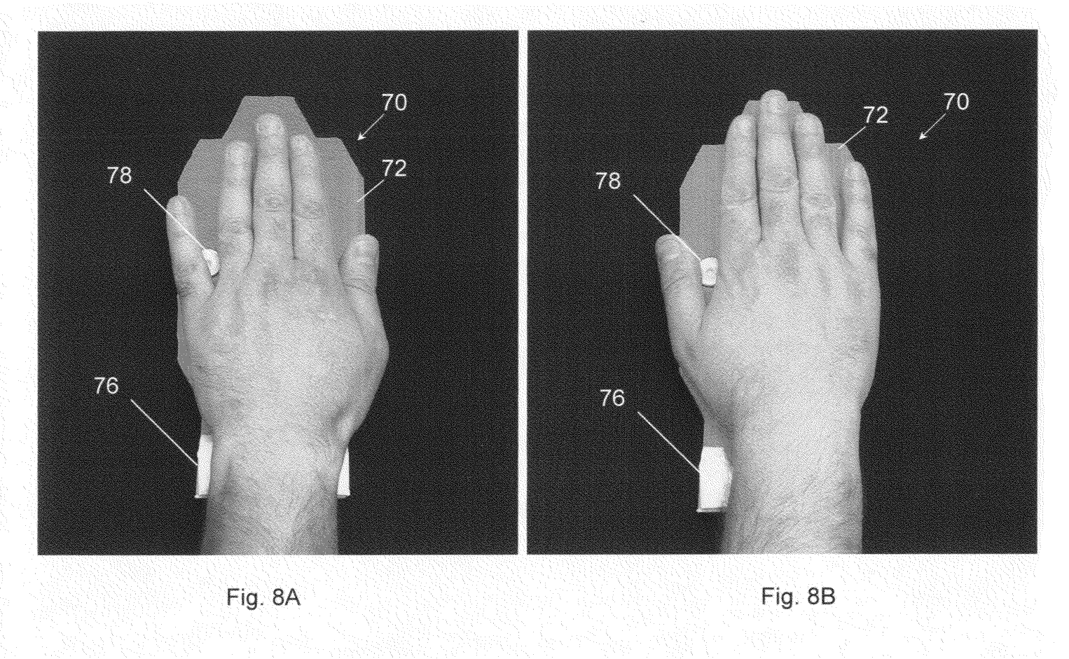

As illustrated in FIGS. 8A and B, an individual's left and right hands are positioned on the top surface 72 of the plate 70 in an embodiment of the present invention. The wrist rests on the support 76. Referring to FIG. 8A, the fiducial marker 78 appear between the fourth and fifth fingers when the LEFT hand in placed on top of the device. In FIG. 8B, the marker 78 is immediately adjacent to the forefinger when the RIGHT hand is placed on the top of the device as shown in FIG. 8B. Thus by examining in the resulting images the spatial relationship of the marker 78 to the anatomy of the hand and wrist, it is possible to determine from that information alone which hand has been imaged. Flipping, rotation, inversion, and other transformations of the image do not change such spatial relationship as the relative positions of markers and hand/wrist are preserved.

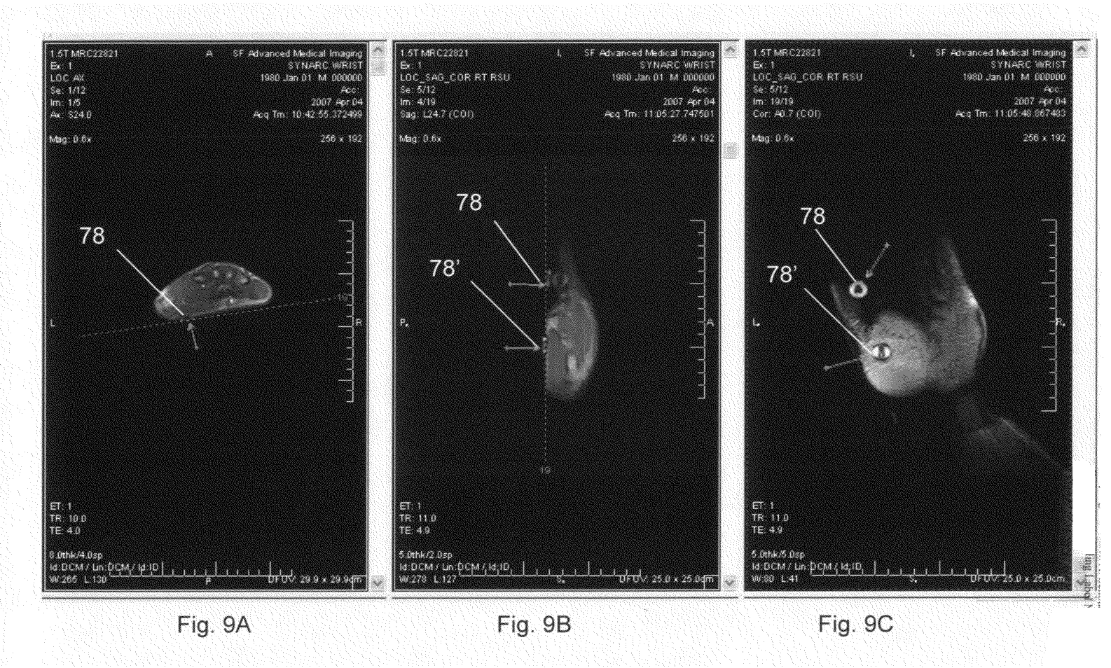

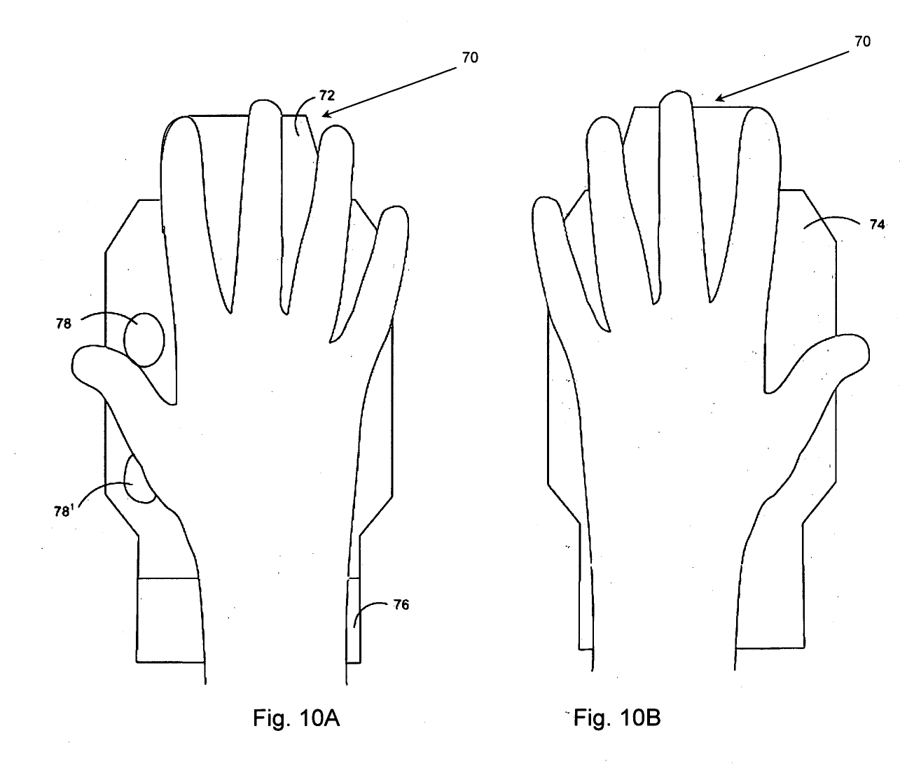

MR images of a right hand placed palm-down on the top surface 72 of the plate 70 are shown in FIG. 9A, B and C in the axial, sagittal, and coronal planes, respectively. The fingers are positioned in approximately the same horizontal plane as the bones of the wrists, and the wrist is straight such that the major axes of the radius and the phalanges are parallel. Two MRI-visible fiducial markers 78 are placed at the top surface 70 near its left edge over the marker. The right hand is positioned such that the right thumb is below marker 78 as illustrated in FIG. 10A. In the resulting MR images as shown in FIGS. 9B and C, the markers 78 appear at the palmar surface beneath the #1 carpal bone (thumb) at the palmar surface, and are visible in some coronal slices through the hand in the images. FIG. 9A shows the alignment of the marker 78 at the palmar surface.

To illustrate how this present embodiment can be used to determine the right/left assignment and orientation of a hand on a medical image if the hand is put on the “wrong” side (bottom surface 74) of the plate 70, a left hand is placed palm-down on the bottom surface 74 of the plate 70 as shown in FIG. 10B, forming a mirror image of the right hand on the top surface 72 of the plate 70 in FIG. 10A. If there are no labels or fiducial markers on the plate marking the right/left assignment of the hand, the resulting medical images taken of the hands from FIGS. 10A and B will be hard to distinguish.

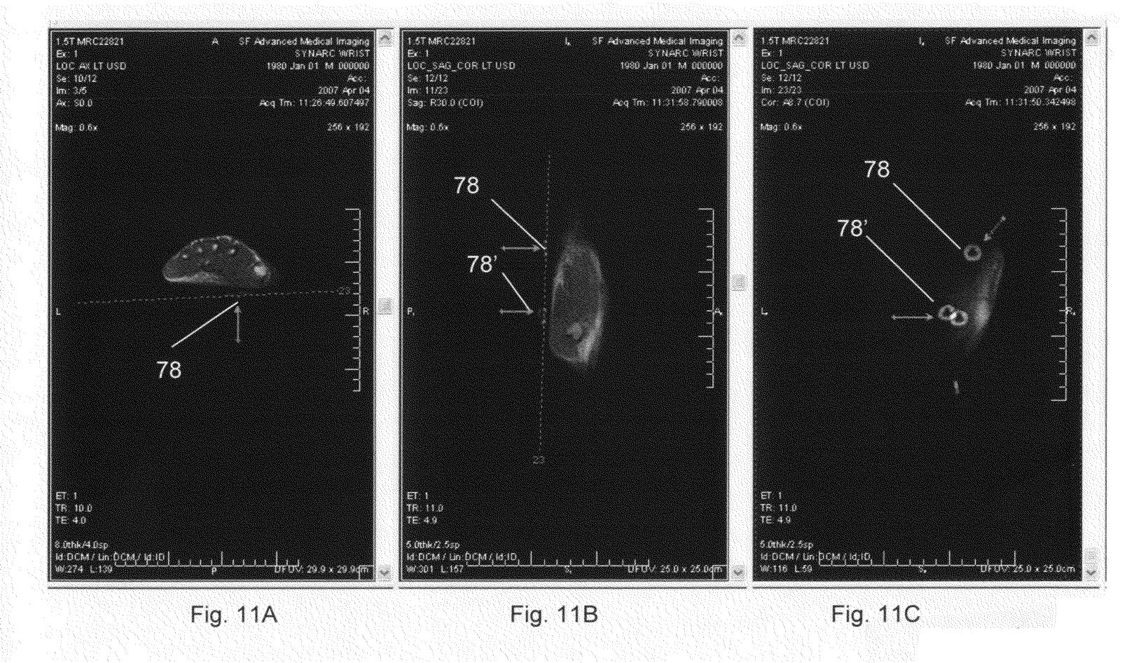

Using fiducial markers 78, a person can easily determine the orientation and right/left assignment on the resulting medical images by measuring the relative distance of the fiducial markers to the hand and the alignment between the palmar surface and the plate 70. FIGS. 11A, B and C are MR images of the left hand on the bottom surface 74 of the plate 70 as illustrated in FIG. 10B. In FIGS. 11B and C, the markers 78 appear beneath the #1 carpal bone, and are distinguishable from FIGS. 9B and C above because the markers in FIGS. 11B and C are several millimeters removed from the palmar surface. Similarly, FIG. 11A shows the fiducial marker 78 is several millimeters removed from the palmar surface, and is distinguishable from FIG. 9A.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

TABLE 1
Relationship of the Location of the Radio-opaque Label in a Radiograph
to the True Anatomy of the Hand Imaged Using the Frame

True Side
of Hand

| Location of Radio-opaque Label | Left | Right |
|---|---|---|
| Above Thumb | L | R |
| Below Thumb | R* | L* |
| Above Little Finger | R | L |
| Below Little Finger | L* | R* |

*“L” and “R” appear rotated 180° relative to the direction of the fingers

TABLE 2
Relationship of the Location of the Radio-opaque Label in a Radiograph
to the True Anatomy of the Foot Imaged Using the Frame

True Side
of Foot

| Location of Radio-opaque Label | Left | Right |
|---|---|---|
| Above or adjacent to Great Toe | L | R |
| Below Great Toe, Medial | R* | L* |
| (adjacent to arch) | | |
| Above Little Toe | R | L |
| Lateral, Below Little Toe | L* | R* |

*“L” and “R” appear rotated 180° relative to the direction of the toes

1. A frame for positioning a hand for medical imaging, the frame comprising:
a plate having a first surface and a second surface; and
at least one indicium of handedness on one of said first and second surface.

2. The frame of claim 1 wherein said at least one indicium is positioned asymmetrically on said one of said first and second surfaces.

3. The frame of claim 1 wherein at least one of said first and second surface is flat.

4. The frame of claim 3 wherein said other of said first and second surface is shaped to raise the fingers of the hand.

5. The frame of claim 3 wherein said other of said first and second surface comprises a raised platform to support the wrist of said hand.

6. The frame of claim 1 wherein the indicium is visible under medical imaging illumination.

7. The frame of claim 1 wherein said medical imaging is selected from a group consisting of: X-Ray, MRI (magnetic resonance imaging), computed tomography (CT), and PET (positron emission tomography).

8. The frame of claim 1 wherein said plate is x-ray transparent or translucent.

9. A method for positioning a hand for medical imaging comprising the steps of:
providing a frame comprising:
a plate having a first surface and a second surface; and
at least one indicium of handedness on one of said first and second surface; and
placing said hand on said plate in close juxtaposition to said indicium of handedness.
